(19) United States
(12) Patent Application Publication
(10) Pub. No.: US 2019/0205899 A1
(43) Pub. Date: Jul. 4, 2019

(54) METHOD AND SYSTEM FOR IDENTIFYING A PRODUCT

(71) Applicant: Robert Bosch GmbH, Stuttgart (DE)

(72) Inventors: Darno Alexander Ketterer, Renningen (DE); Raluca Maria Litynski, Karlsruhe (DE)

(21) Appl. No.: 16/312,493

(22) PCT Filed: Jun. 22, 2017
(86) PCT No.: PCT/EP2017/065443

§ 371 Date: Dec. 21, 2018

(30) Foreign Application Priority Data
Jun. 28, 2016 (DE) 10 2016 211 606.1

(51) Int. Cl. G06Q 30/00; G06F 16/2455; G06K 9/46

(52) U.S. Cl. CPC G06Q 30/0185; G06K 19/06028; G06K 9/46; G06F 16/24558

(57) ABSTRACT

A method for the at least partially automated identification, in particular, for the invalidation, uniqueness check and/or authenticity check, of a product, at least one representation of the product being recorded in at least one detection step, the representation being compared in at least one test step with at least one reference representation of the product in an original state, a presence being checked of at least one feature of the product that has been added as compared to the original state.

### FIELD OF THE INVENTION

The present invention relates to a method and system for identifying a product.

### BACKGROUND INFORMATION

A so-called couponing is from the marketing sector, in which a buyer of a product, in order to participate in a bonus program, may cut out and send in, for example, a barcode or a QR code or a different clearly and uniquely assignable identifier printed on the product. Corresponding barcodes must be uniquely produced and individually recognized and analyzed after submission, for example, in a corresponding service center, to be able to clearly associate a particular product with a particular user.

### SUMMARY OF THE INVENTION

The present invention relates to a method for the at least partially automated identification, in particular, for invalidation, uniqueness check and/or authenticity check, of a product, at least one representation of the product being recorded in at least one detection step, which is carried out, in particular, with at least one mobile device, the representation being compared with at least one reference representation of the product in an original state in at least one test step, which is carried out with at least one data processing device, a check being made for the presence of at least one feature of the product that has been added, in particular, by a user, as compared to the original state.

A product shall be understood to mean, in particular, at least one part of a manufactured article and/or object and/or its packaging advantageously provided for a use by a user. The product may encompass the article and its packaging. The product may, for example, encompass, in particular, merely one part of the article and/or of the packaging, for example, at least one barcode and/or one EAN barcode and/or at least one QR code and/or at least one label and/or at least one lettering and/or at least one sticker and/or at least one RFID chip of the article and/or of the packaging. “Provided” shall be understood to mean, in particular, specifically programmed, configured and/or equipped. An object being provided for a specific function shall be understood to mean, in particular, that the object fulfills and/or carries out this particular function in at least one application state and/or operating state. A method being provided for a purpose shall be understood to mean, in particular, that the method includes at least one method step aimed specifically for that purpose and/or that the method is directed specifically to that purpose and/or that the method is used to fulfill that purpose and is at least partially optimized for such fulfillment.

A representation of the product shall be understood in this context to mean, in particular, at least one, advantageously digital, data set and/or its interpretation by a suitable processing unit. The representation of the product may, for example, encompass at least parts of at least one image, for example, of a photograph and/or video recording of the product and/or its analysis. The representation may, for example, also encompass at least one database entry. It is further conceivable that the representation encompasses, for example, at least one result of at least one scan of at least one barcode and/or of at least one QR code and/or of at least one RFID chip and/or of at least one label and/or of other active and/or passive transmission units and/or of an NFC tag of the product. The representation encompasses, in particular, a combination of the results of multiple scans.

A reference representation of the product in an original state shall be understood in this context to mean, in particular, a representation of the product in a delivery state and/or in a state after manufacturing and before a delivery and/or a representation of a product type of the product and/or of a product category of the product and/or of a sample image of the product. A format of the representation of the product, in particular, corresponds at least essentially to a format of the reference representation of the product.

The detection step advantageously encompasses at least one pre-detection step, which is carried out, which may be by a user, with the aid of the mobile device, for example, with the aid of a camera and/or with a tablet and/or with a smartphone and/or with data goggles. A pre-detection of the product created in the pre-detection step is particularly advantageously conveyed to the data processing device, in particular, to a server, for example, via an internet. The representation of the product may be created, in particular, by the data processing device, based on the pre-detection of the product. It is also conceivable that the representation of the product, based in particular, on the pre-detection of the product, is created with the aid of the mobile device. In this case, in particular, the representation of the product is conveyed to the data processing device. The test step may be particularly carried out with the aid of the data processing device. The reference representation of the product is stored, in particular, in the data processing device, for example, in a database of a server. The data processing device may include at least one processing unit.

A presence of at least one disruptive feature differing from the added feature may be advantageously checked in the test step. The disruptive feature in this case may, for example, encompass damage and/or contamination and/or, in particular, a change and/or manipulation and/or deletion and/or removal of features carried out intentionally by a user, by which the product differs from its original state. It may be advantageously recognized in the test step whether the product exhibits a new or a used condition.

Advantageous properties with respect to product identification, in particular, may be achieved by a method according to the present invention. A cost-efficient and/or simple and/or rapid and/or reliable method for an invalidation, uniqueness check and/or authenticity check may be advantageously provided. A uniqueness of a product may advantageously also be checked without individualizing the product during manufacture. Furthermore, a user action such as, in particular, a marking, a labelling and/or damage, carried out on a product may advantageously be recognized and/or verified, in particular, afterwards. A novelty of a product may advantageously also be reliably checked. Furthermore, an individual product may advantageously be rapidly and/or reliably and/or uniquely assigned to an individual user. A simple implementability of a loyalty program may also be enabled.

In one advantageous embodiment of the present invention, it is provided that in at least one method step, in particular, at least in the detection step, at least one digital image analysis of at least one image of the product is carried out. The image corresponds, in particular, to at least one part of the pre-detection of the product. The image of the product may be a, in particular, digital photograph and/or video recording. The image of the product may be particularly created by the user, in particular, using the mobile device. The product in this case may be wholly or partially reproduced in the image. The image of the product may, for example, be a photo of the entire product, in particular, of an article and/or of its packaging. The image of the product may, for example, also be a photo of a part of the product, for example, of a part of a packaging, in particular, of a QR code and/or of a barcode and/or of an EAN barcode and/or of a label and/or of a sticker. Great convenience may be advantageously achieved as a result, in particular, since a detection may be carried out using a mobile terminal device of a user and advantageously directly by the user.

In one particularly advantageous embodiment of the present invention, it is provided that the image analysis encompasses at least an optical character recognition. For example, one part and/or one position of a barcode and/or of a QR code and/or of a label may be recognized with the aid of the character recognition. The character recognition is advantageously carried out in one section of the image, selected and/or marked, in particular, by the user. The character recognition particularly advantageously encompasses at least one comparison with a database, for example, a probability detection of a match based on a text recognition and/or on a recognition of individual letters and/or numbers and/or characters. At least one deep learning data structuring of at least the section of the image may take place in conjunction with the image analysis and, in particular, during the image analysis, in order, for example, to be able to more quickly recognize the section and/or its contents and/or similar contents upon a further query. As a result, a rapid capturing may advantageously take place. Text features and/or character features added and/or removed, in particular by a user, may also be recognized as a result.

In another embodiment of the present invention, it is provided that at in at least one method step, in particular, at least in the test step, a data comparison with a database, in particular, with a database of the data processing device, is advantageously carried out with the aid of the data processing device. The reference representation of the product is advantageously stored in the database. The data comparison particularly advantageously encompasses at least one comparison of results of the image analysis with corresponding results of an image analysis of the reference representation of the product, the reference representation being able to be configured, in particular, as the result of an image analysis. In this way, an added feature of a product may advantageously be rapidly and/or reliably recognized and/or a novelty of a product may be checked.

It is further provided that the added feature is a uniqueness feature. The product differs from other products of the same model and/or of its type, in particular, by the added feature. The product may be clearly identified based on the added feature and, in particular, be assigned to the user in the test step. The product is particularly advantageously individualized at least by the added feature. In this way an individual and/or individualized product may advantageously be clearly identified.

In one embodiment of the present invention, it is provided that a user is prompted in at least one invalidation step to add the feature to the product, in particular, at least with the aid of a message and/or of a visual prompt and/or of a textual prompt and/or of an acoustic prompt, which may be on a display of the mobile device. The user is prompted to add a feature to the product which may be only when the product is in an original state and/or when a lack of an added feature is recognized, as a result of which a repeated invalidation of the same product may be advantageously prevented. A type and/or a nature and/or a configuration of the feature to be added is advantageously specified and/or provided to the user and, in particular, is determined by the data processing device. The database particularly advantageously includes pieces of information about uniqueness features already present on other products, in particular, products of the same model and/or of the same type. The pieces of information about uniqueness features already present on other products are processed, in particular, in order to select the feature to be added. The feature to be added may differ at least from all uniqueness features present in the database that are associated with other products of the same model. If the product encompasses a device or a device with its packaging, the invalidation step is advantageously carried out prior to the initial operation of the device. It is conceivable that the device may be used only after carrying out the invalidation step. The device may be locked, for example, and unlocked only after carrying out the invalidation step, which may be with the aid of at least one signal transmission from the data processing device to the device. This advantageously enables a user to invalidate and/or to individualize a product.

In one particular embodiment, it is provided that the added feature is recognized in at least one validation step. At least one validation representation of the product with the added feature is advantageously recorded in the validation step and is processed particularly advantageously by the data processing device. In the process, the added feature may be recognized based on a comparison of the validation representation of the product with the reference representation, and particularly may be stored in the database. In this way, an invalidation and/or identification of a product carried out by a user may be advantageously recognized.

In one advantageous embodiment of the present invention, it is provided that in at least one assignment step, an added feature recognized in the validation step is assigned to a dataset of the product stored, in particular, in the data processing device. A purchase of the product may be documented by centrally storing the added feature, advantageously in the database. The added feature is advantageously clearly linked in the validation step with the user, in particular, with a personal piece of information of the user such as, for example, a user name and/or a user ID and/or a customer number, and/or is clearly assigned to the user. The piece of information that the product has been individualized with the aid of the added feature is particularly advantageously stored in the assignment step. If, after the addition of the feature, the product is recorded again in a detection step, the added feature is recognized in a new test step. In the test step, the representation of the product may be also compared with the validation representation of the product. The product in this case is recognized as invalidated and/or as sold and/or as used and/or as individualized. In this way, an individual or individualized product may be advantageously linked with a user.

In one particular advantageous embodiment of the present invention, it is provided that at least one action is initiated, in particular, by the data processing device, due to the assignment. A user is advantageously credited bonus points if the user is enabled for at least one rebate action and/or if the user is earmarked for an at least partial purchase price refund. It is further conceivable that various products are assigned to the user, at least one of which has been invalidated and/or registered with the aid of the method according to the present invention, for example, in the manner of a virtual shopping cart and/or of a virtual inventory. In this way, the user may be advantageously ensured participation in a loyalty program.

It is also provided that the added feature is situated on a surface of the product. The added feature may encompass at least a manual lettering and/or painting, for example, at least one symbol, one or multiple lines, one or multiple letters and/or numbers or the like. The user is advantageously prompted in the invalidation step to add a particular lettering and/or painting to the product as a uniqueness feature. The user is particularly advantageously prompted to letter and/or to paint at least a part of the product, for example, a part of a device and/or at least a part of a packaging, the user being shown and/or specified a type of lettering and/or painting, for example, with the aid of the display of the mobile device. For example, the user may be prompted to invalidate a barcode and/or a QR code using a pin, to at least partially paint on a logo and/or to write a character sequence, for example a name and/or a customer number and/or a customer ID and/or a user name on the product and/or to paint over or to obscure numbers and/or number sequences and/or symbols and/or letters and/or letter sequences or the like. In this way, it is advantageously possible to individualize a product in a reliable and checkable manner.

The present invention further relates to a system for the identification, in particular, for the invalidation, uniqueness check and/or authenticity check of a product, in particular, with the aid of a method as described herein, using at least one device which is provided for recording a representation of the product, and using at least one data processing device, which is provided for comparing the representation of the product with at least one reference representation of the product in an original state and for checking a presence of at least one feature of the product added, in particular, by a user, as compared to the original state.

With a system according to the present invention, it is possible to obtain, in particular, advantageous properties with respect to a product identification. A cost-efficient and/or simple and/or rapid and/or reliable system may be advantageously provided for an invalidation, a uniqueness check and/or an authenticity check. Furthermore, a uniqueness of a product may advantageously be checked without individualizing the product during manufacture. A user action carried out on a product such as, in particular, a marking, an identification and/or damage may advantageously also be recognized and/or verified, in particular, afterwards. In addition, a novelty of a product may advantageously be reliably checked. Furthermore an individual product may advantageously be rapidly and/or reliably and/or uniquely assigned to an individual user. A simple implementability of a loyalty program may also be enabled.

Advantageous properties with respect to a high degree of operating convenience and/or an easy handling may be achieved, in particular, if the device is configured as a mobile device, for example, as a smartphone, a tablet or as data goggles. It is also conceivable that the device has a stationary configuration, for example, as a, in particular, permanently installed camera.

Advantageous properties with respect to a simple and/or reliable and/or comprehensive data management and/or data preparation and/or data processing may be achieved, in particular, if the data processing device is configured as a server, to which the device is connectable via a data network.

The method according to the present invention, as well as the system according to the present invention, are not intended to be limited here to the application and to the specific embodiment described above. The method according to the present invention and the system according to the present invention may, in particular, include a number of individual elements, components and units differing from the number cited herein to fulfill a functionality described herein.

Additional advantages result from the following drawing descriptions. An exemplary embodiment of the present invention is depicted in the drawing. The drawing, the description and the claims contain numerous features in combination. Those skilled in the art will purposely also consider the features individually and combine them to form additional meaningful combinations.

### BRIEF DESCRIPTION OF THE DRAWINGS

FIG. 1 shows a flow chart of a method for the at least partially automated identification of a product.

FIG. 2 shows a system for identifying a product in a schematic representation.

FIG. 3 shows a barcode of the product as well as various options for added features in a schematic representation.

FIG. 4 shows the barcode of the product as well as additional options for added features in a schematic representation.

FIG. 5 shows the barcode of the product as well as additional options for added features in a schematic representation.

FIG. 6 shows a device of the product and potential added features in a schematic representation.

### DETAILED DESCRIPTION

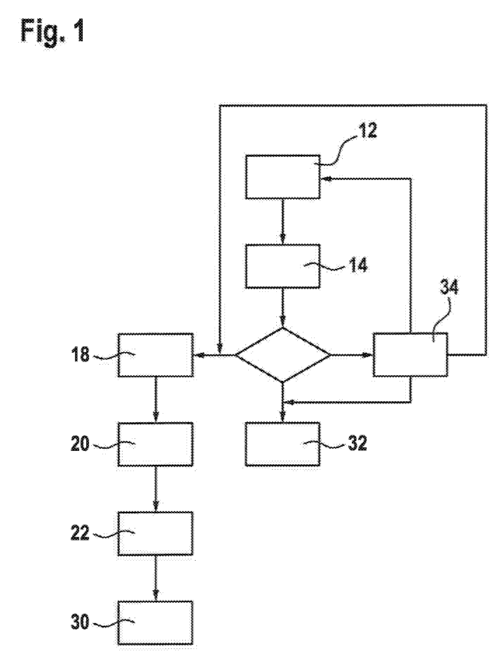

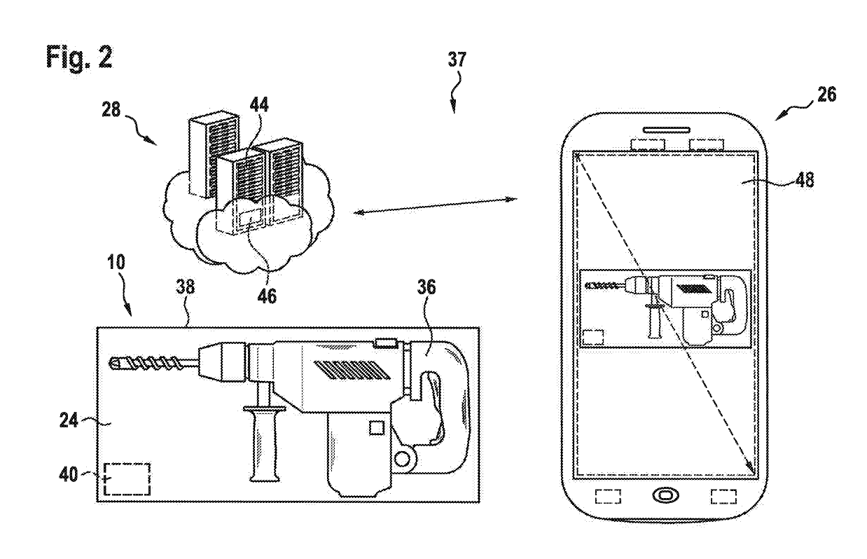

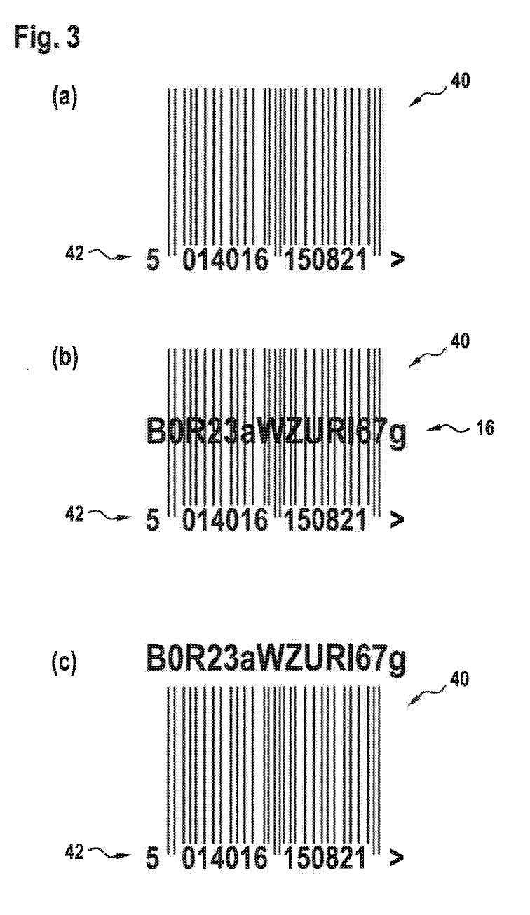

FIG. 1 schematically shows a flow chart of a method for the at least partially automated identification of a product 10 (cf. FIG. 2). In at least one detection step 12, at least one representation of product 10 is recorded, in the present case, with the aid of a device 26 (cf. FIG. 2). The representation of product 10 is compared in at least one test step 14 with at least one reference representation of product 10 in an original state, in the present case, with the aid of a data processing device 28 (cf. FIG. 2). In the test step 14, a presence of an added feature 16 compared to the original state (cf. FIGS. 3 through 5) of product 10 is checked. A presence of a disruptive feature of product 10 varying from added feature 16 is also checked in test step 14 based on the comparison of the representation of product 10 with the reference representation of product 10. The disruptive feature may, for example, be damage to and/or contamination of product 10. Added feature 16 is a uniqueness feature. Product 10 is individualized due to added feature 16.

A data comparison with a database takes place at least in test step 14, in the present case, with a database of data processing device 28. The reference representation of product 10 is stored in the database.

If a lack of added feature 16 is recognized in test step 14, a user is prompted in at least one invalidation step 18 to add feature 16 to product 10. Feature 16 added by the user is recognized in at least one validation step 20. Validation step 20 takes place after invalidation step 18. Added feature 16 is recognized for the first time in validation step 20. A validation representation of product 10 is recorded in validation step 20. The validation representation of product 10 is stored in the database.

In at least one assignment step 22, feature 16 recognized in validation step 20 is assigned to at least one stored dataset of product 10. The stored dataset of product 10 in the present case is stored in data processing device 28.

Due to the assignment, at least one action is initiated in an action step 30. In the present case, a piece of information about an invalidation of product 10 is stored by the user in the database. A purchase of product 10 is documented as a result of the invalidation. The user may, for example, participate in a loyalty program as a result of the documented purchase.

If a presence of added feature 16 is recognized in test step 14, the user is informed of the presence of added feature 16 in a first information step 32, in the present case, with the aid of device 26. In this case, an invalidation of product 10 may no longer be made, since product 10 is already invalidated. A multiple invalidation of product 10 may be prevented.

If a presence of a disruptive feature is recognized in test step 14, the user may be informed of the presence of the disruptive feature in a second information step 34. The disruptive feature may, for example, be marked for the user on an image of product 10, thus advantageously enabling the user to find and remove the disruptive feature. If feature 16 is recognizable in spite of the presence of the disruptive feature, the user is informed of the presence of added feature 16 in first information step 32. If no presence of added feature 16 is recognized, and the disruptive feature is identified as non-critical with respect to the addition of feature 16, the user is prompted in invalidation step 18 to add feature 16 to product 10. Validation step 20 is subsequently carried out. The validation detection is stored in the database and correspondingly also encompasses a representation of the disruptive feature. Thus, for example, contamination of and/or damage to product 10 may be stored in the database and, in particular, be used for a later identification and/or novelty check of product 10. If the disruptive feature is interpreted as obstructing the detection of product 10, the user is prompted to record a representation of product 10 once again in a new detection step 12, which may be after removing the disruptive feature. It may, in particular, be recognized in test step 14, if no representation of product 10 has been recorded in detection step 12, but rather, for example, an image of the surroundings, or if product 10 is not recognizable based on a recorded representation. In this case, for example, the disruptive feature may be an article, which is standing or lying in front of product 10 and which at least partially conceals product 10 when recording an image. In this case, it is conceivable that data processing device 28 is provided to recognize articles different from product 10. The user may then be specifically informed of the presence and of the nature of a disruptive article.

FIG. 2 shows a system 37 for identifying product 10 with the aid of the method outlined in FIG. 1 in a schematic representation. System 37 encompasses data processing device 28 and device 26. Device 26 in this present case is configured as a smartphone. Device 26 is provided for recording the representation of product 10. In the present case, an image of product 10 may be recorded with the aid of a smartphone camera, not shown, of device 26.

Data processing device 28 in the present case is configured as a server, to which device 26 is connectable via a data network, in the present case, via an internet. Data processing device 28 is provided to compare the representation of product 10 with the reference representation of product 10 in the original state and to check the presence of at least added feature 16 compared to the original state (cf. FIGS. 2 through 5) of product 10. Data processing device 28 in the present case includes at least one data memory unit 44 and at least one processing unit 46 having suitable programming for carrying out the described method steps.

Product 10 in the present case encompasses a device 36 and a packaging 38. Packaging 38 in the present case includes a barcode 40 (cf. also FIGS. 3 through 5). Alternatively, a sticker, a label, a QR code or the like may be present instead of barcode 40. As mentioned above, however, it is conceivable, in principle, that a product is understood to mean merely a part of a finished article and/or of its packaging and, in particular, a barcode and/or a QR code or the like.

In detection step 12, in particular, in a pre-detection step of detection step 12, a user may use device 26 to record a pre-detection of product 10, which is transmitted by device 26 to data processing device 28. A representation of product 10 is also ascertained in detection step 12 from the pre-detection. In the present case, the pre-detection is an image of product 10 in the form of a digital photograph. At least one digital image analysis of at least the image of product 10 is carried out in detection step 12. Alternatively or in addition, it is conceivable that an image analysis of an image of product 10 is carried out in another method step. The image analysis encompasses at least one optical character recognition. In the present case, barcode 40 is recognized and a character sequence 42 (cf. FIG. 3) of barcode 40 is ascertained with the aid of the character recognition. It is conceivable that the user marks an area to be analyzed, in the present case, barcode 40, for example, on a display 48 of the device. In the present case, the user records an image of packaging 38 of device 36. The representation of product 10 is also ascertained in the present case from the pre-detection by data processing device 28. In the present case, the image analysis is also carried out by data processing device 28. However, it is also conceivable that a corresponding device includes a suitable processing unit, which is provided for executing a suitable program, with the aid of which the detection step and/or the test step and/or other method steps is/are carried out.

FIGS. 3 through 5 schematically show representations of barcode 40 of product 10, as well as various exemplary options for added features 16. Added feature 16 (cf. FIG. 3b) is situated on a surface 24 of product 10. In the present case, surface 24 is a packaging surface of packaging 38. Added feature 16 encompasses at least a manual lettering and/or painting (cf. FIGS. 3 through 5).

Barcode 40 encompasses character sequence 42. After purchasing product 10, for example, the user in the present case may log in to a customer center via a suitable program, which is executed by device 26, in the present case via a smartphone app. There, the user is displayed a virtual inventory of his/her devices. After the purchase, the user may invalidate product 10 in order to participate in a loyalty program and to collect bonus points, for example and or to obtain refunds. The user is prompted to record an image of product 10, in the present case, of packaging 38 of product 10, or at least of barcode 40. Product 10 is recognized by data processing device 28 as new, since it includes neither a disruptive feature nor an added feature. In invalidation step 18, the user is prompted via display 48 of device 26 to add a particular feature 16 to product 10. In the present case (cf. FIG. 3b), the user is prompted to write a particular character sequence as feature 16 on barcode 40. Such a character sequence may, for example, encompass a customer name, a user ID, a user name, a dealer number, an association number, a date, a signature, a regional code, a place code, a zip code and/or a locality. It is further conceivable that based on such user information, data processing device 28 generates a code to be written, for example, through at least partial checksum formation based on ASCII values. The user subsequently records an additional image of product 10 in validation step 20, in order to store added feature 16 and to link it to his/her user account.

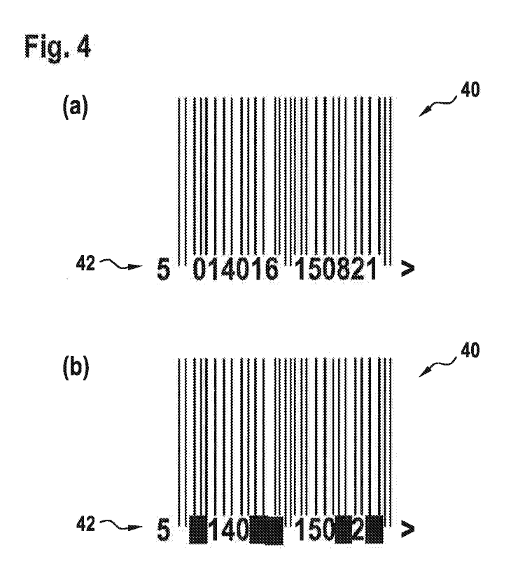

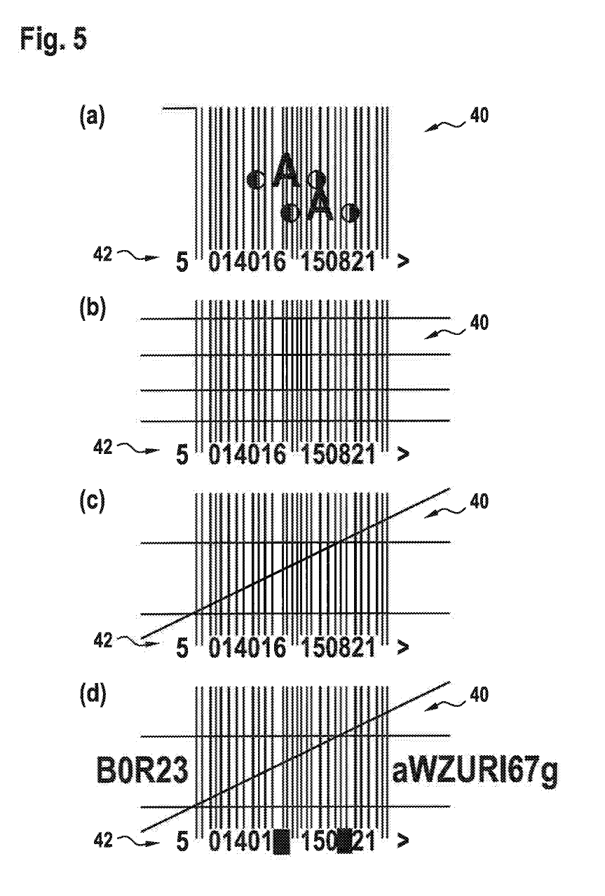

As shown in FIG. 3c, an added feature may also be situated above barcode 40, for example. An arrangement below a barcode is, of course, also conceivable. An added feature may also be an overpainting of selected characters of barcode 40, as shown in FIG. 4b. Combinations of letters and symbols may also be used, as shown in FIG. 5a. The user may also be prompted to draw particular lines over barcode 40, as shown in FIGS. 5b and 5c. Combinations of these variants are, of course, also conceivable, as delineated, in particular, in FIG. 5d.

The image analysis may also encompass various other image analytical methods alternatively or in addition to character recognition. For example, the image analysis may be provided to recognize a kind and/or a type of a product and/or general varying articles, for example, based on a database comparison. In this case, selected image pixels of the image of the product, in particular and, in particular, their color information, may be pre-processed, in order to enable a rapid recognition with the aid of a comparison of pre-processed information with pieces of information stored in the database, without analyzing the entire image. In addition, a frequency of occurring colors may be analyzed and compared with stored pieces of information. It is also conceivable that an image encompasses at least one video recording and/or multiple photographs from various viewing angles and/or from various distances. In this way, for example, an article behind a transparent or semi-transparent packaging surface such as, for example, a blister foil, may be recognized with the aid of a suitable comparison of various image components and/or of various images. In this way, a packaging as well as a device situated in the packaging may, in particular, be simultaneously recognized. In the case of curved product surfaces, in particular, multiple images and/or at least one video recording may be used to be able to detect lettering, paintings, contaminations and the like in their entirety, which are not fully visible from a single viewer position.

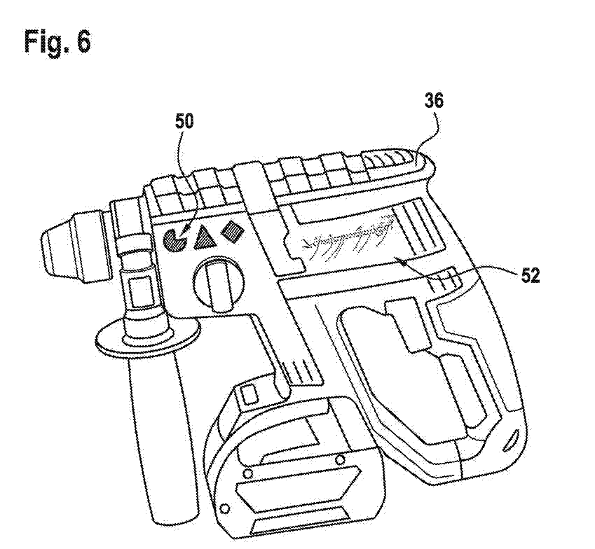

FIG. 6 shows device 36 of product 10 and potential added features 50, 52 in a schematic representation. A first added feature 50 is made up of multiple hand-painted symbols. A second added feature 52 is made up of handwritten lettering. In the present case, the user has the additional option of individualizing device 36 after invalidation and registration of product 10 once it is purchased, and storing a validation representation of individualized device 36 in a database in a further validation step. A validation representation of a packaging containing pieces of 3D information may similarly be stored. Storage may take place in each case in a data memory of device 26, in addition or alternatively to storage in the database of data processing device 28. In this way, individual device 36 may be clearly assigned to the user.

It is also conceivable that at least one feature is added merely to a device and not to its packaging, in order to invalidate and/or to identify a corresponding product as described. Furthermore, an invalidation may also include a scanning of a RFID chip situated in the product, for example, in a device of the product or in its packaging. In addition, an authenticity of a new or used product may be checked with the aid of the described method, as a result of which plagiarisms may be advantageously recognized and or plagiarizing may be prevented.

1-14. (canceled)

15. A method for providing at least partially automated identification of a product, the method comprising:
recording, in at least one detection step, a representation of the product;
comparing, in at least one test step, the recorded representation with at least one reference representation of the product in an original state; and
checking a presence of at least one feature of the product that has been added as compared to the original state.

16. The method of claim 15, further comprising:
performing at least one digital image analysis of at least one image of the product.

17. The method of claim 16, wherein the image analysis encompasses at least one visual character recognition.

18. The method of claim 15, further comprising:
performing a data comparison with a database.

19. The method of claim 15, wherein the added feature includes a uniqueness feature.

20. The method of claim 19, wherein a user is prompted in at least one invalidation step to add the feature to the product.

21. The method of claim 20, wherein the added feature is recognized in at least one validation step.

22. The method of claim 21, wherein the added feature recognized in the validation step is assigned in at least one assignment step to at least one stored dataset of the product.

23. The method of claim 22, wherein at least one action is initiated due to the assignment.

24. The method of claim 15, wherein the added feature is situated on a surface of the product.

25. The method of claim 15, wherein the added feature encompasses at least one manual lettering and/or painting.

26. A system for the identification of a product, comprising:
at least one device, which is provided for recording a representation of the product;
at least one data processing device, which is provided for comparing the representation of the product with at least one reference representation of the product in an original state and for checking a presence of at least one feature of the product that has been added as compared to the original state.

27. The system of claim 26, wherein the device includes a mobile device.

28. The system of claim 26, wherein the data processing device includes a server, to which the device is connectable via a data network.

29. The system of claim 26, wherein the device includes a mobile device, which includes a smartphone, a tablet or data goggles.

30. The system of claim 26, wherein the at least partially automated identification includes at least one of an invalidation, a uniqueness check and/or am authenticity check of a product.

31. The method of claim 15, wherein the at least partially automated identification includes at least one of an invalidation, a uniqueness check and/or am authenticity check of a product.
